(19) United States
(12) Patent Application Publication
(10) Pub. No.: US 2023/0187133 A1
(43) Pub. Date: Jun. 15, 2023

(54) ELECTRODE FORMING METHOD USING DIFFERENT MATERIALS, AND ELECTRONIC DEVICE MANUFACTURING METHOD AND ELECTRODE FORMING APPARATUS USING SAME

(71) Applicant: Gosantech Co., Ltd, Cheonan-si (KR)

(72) Inventor: Jaeryul YU, Cheonan-si (KR)

(73) Assignee: Gosantech Co., Ltd, Cheonan-si (KR)

(21) Appl. No.: 17/989,084

(22) Filed: Nov. 17, 2022

(30) Foreign Application Priority Data
Dec. 10, 2021 (KR) 10-2021-0176550

(51) Int. Cl. H01G 4/005

(52) U.S. Cl. CPC H01G 4/005; H01G 4/30

(57) ABSTRACT

Proposed is a method of forming an electrode of an electronic device for manufacturing the electronic device, the method including forming a boundary line corresponding to an edge of an electrode pattern by inkjet printing, and forming an electrode body filled inside the boundary line by inkjet printing, wherein height and width of the electrode pattern are controlled by limiting ink printed in the electrode body formation such that the ink is prevented from going to an outside by the boundary line. The electrode body is formed after first forming the boundary line to prevent the spreading of ink ejected by inkjet printing, thereby increasing the precision of the electrode pattern which is the effect of inkjet printing and enabling the formation of the electrode having height which cannot be achieved by conventional inkjet printing.

### CROSS REFERENCE TO RELATED APPLICATION

The present application claims priority to Korean Patent Application No. 10-2021-0176550, filed Dec. 10, 2021, the entire contents of which is incorporated herein for all purposes by this reference.

### BACKGROUND OF THE INVENTION

### Field of the Invention

The present disclosure relates generally to a method of forming an electrode of an electronic device. More particularly, the present disclosure relates to a method of forming an electrode of an electronic device by inkjet printing.

### Description of the Related Art

An electronic device refers to an electronic component using conduction of electrons moving in a solid, and electrodes for moving electricity are formed in the electronic device.

Various types of electrodes are formed according to the characteristics of various electronic devices, and as the miniaturization and precision of an electronic device progresses, the size of an electrode decreases and the shape of the electrode is required to be more precise.

A multilayer ceramic capacitor (MLCC), which is one of electronic devices, is a capacitor manufactured by stacking ceramics as the name suggests.

A capacitor is composed of conductive plates (electrodes) spaced apart from each other and a dielectric positioned therebetween, and when a voltage is applied between the conductive plates that are spaced apart from each other, the electric charges of negative and positive poles are induced in the conductive plates to generate electrical attraction. Electric charges are collected and energy is stored between the conductive plates by the electrical attraction formed in the conductive plates, and after the energy is stored as much as the capacity of the capacitor, no current flows. The capacitor is sometimes expressed as a condenser due to the characteristic of storing and collecting energy. In addition to the function of storing energy, the capacitor may perform the function of filtering direct current and allowing only alternating current to flow and may be used with a diode to form a rectifier circuit that converts an alternating current to a direct current. Particularly, the capacitor collects charges when a voltage is high and discharges charges when a voltage is low to maintain the potential difference of the same magnitude as a power supply voltage and resists changes in a voltage and prevents sudden change in the voltage. Accordingly, the capacitor stably controls the flow of electricity in an electronic product and prevents electromagnetic interference between parts, and thus is often used in precision electronic products.

Various types of capacitors are being manufactured according to the quality of materials or materials of the capacitors, and a type of capacitor that has been used the most recently is a ceramic capacitor. The ceramic capacitor is a capacitor using ceramic as a dielectric, and has the advantage of realizing high capacitance by using ceramics with properties of paraelectric or ferroelectric. An MLCC is a type of ceramic capacitor, and through a structure in which a ceramic dielectric and an electrode are alternatively stacked, high-capacitance device with a small size can be manufactured and devices having various shapes and capacities according to various purposes can be manufactured.

An MLCC is used as a surface mount device (SMD) that is directly mounted on a circuit board due to a small size thereof, 800~1000 MLCCs are used in a smartphone, 1200 MLCCs are used in a PC, and 2000 MLCCs are used in an LED TV. As electronic devices used in an automobile increase and interest in an electric vehicle and autonomous driving increases, demand for MLCCs for the electronic devices of an automobile is increasing. Currently, about 3,000 MLCCs are used in a general automobile and 15,000 MLCCs are used in an electric vehicle, and the price of a current MLCC is higher than the price of an existing MLCC.

FIG. 15 is a flowchart illustrating a general MLCC manufacturing process.

As the manufacturing process of an MLCC, an MLCC is manufactured by stacking each dielectric sheet on which an electrode is formed after forming the electrodes on the surface of the dielectric sheets made of ceramic materials. Specifically, each of electrode patterns is formed in the shape of an Ni electrode on a dielectric sheet such as a green sheet, and the dielectric sheets on which the electrode patterns are formed are stacked and pressed and then are cut to have predetermined sizes, and are calcined and sintered to form a stacked structure in which electrodes face each other with a dielectric placed therebetween. Next, the MLCC is manufactured by forming external electrodes connected with the stacked electrodes.

In general, the process of forming an electrode pattern on a dielectric sheet is performed by screen printing. Conventionally, the thickness of the dielectric sheet is thick and the size and precision of a required MLCC are not high, so there is no problem even when the electrode pattern is formed by screen printing. However, as demand for small-sized MLCCs gradually increases, a dielectric sheet with a thinner thickness has been developed. As demand for a precise MLCC increases, it is necessary to form a smaller and more precise electrode pattern, which is difficult to be manufactured by the conventional screen printing.

Accordingly, various techniques for forming an electrode pattern through inkjet printing, which enables more precise pattern formation, have been studied. When forming an electrode pattern through inkjet printing, the electrode pattern can be precisely printed to have a desired shape, but due to the characteristics of inkjet printing, the thickness (height of the electrode pattern from a dielectric sheet) of the electrode pattern is excessively thin. When ejecting a thick droplet of ink to maintain thickness of an electrode, viscosity of the ink is low due to the characteristics of the inkjet printing by which the droplet is formed, so the ink spreads and the width of the electrode pattern changes.

Accordingly, techniques to form not only an electrode pattern but also a dielectric layer on a dielectric sheet by inkjet printing are being studied, but cause overall process time to be increased compared to when only a dielectric sheet is used in a current technique by which a dielectric sheet is sufficiently thin.

Accordingly, in the process of forming an electrode of an electronic device, efforts have been made to apply inkjet printing but the field of the application of the inkjet printing is limited by the characteristics of the inkjet printing.

### Documents of Related Art

(Patent Document 1) Korean Patent No. 10-0558448
(Patent Document 2) Korean Patent No. 10-0606235

### SUMMARY OF THE INVENTION

Accordingly, the present disclosure has been made keeping in mind the above problems occurring in the related art, and the present disclosure is intended to propose a new method in which the aspect ratio of an electrode pattern can be controlled while precision of the pattern formed by inkjet printing is maintained.

In order to achieve the above objective, according to one aspect of the present disclosure, there is provided a method of forming an electrode of an electronic device for manufacturing the electronic device, the method including: forming a boundary line corresponding to an edge of an electrode pattern by inkjet printing; and forming an electrode body filled inside the boundary line by inkjet printing, wherein height and width of the electrode pattern are controlled by limiting ink printed in the electrode body formation such that the ink is prevented from going to an outside by the boundary line.

According to the present disclosure, since the electrode is formed through inkjet printing, the precision of the electrode pattern which is the effect of the inkjet printing may be increased, and further, after the boundary line which prevents the spreading of ink is first formed, the electrode body may be formed, thereby realizing height of an electrode which cannot be achieved by a conventional inkjet printing.

By controlling height of ink printed in the boundary line formation, maximum height and height deviation of the electrode body printed may be controlled.

When the height of the inkjet-printed boundary line is excessively low compared to the target height of the electrode body, ink of which the boundary line is formed may not prevent the spreading of ink of which the electrode body is formed.

Meanwhile, as the height of the inkjet-printed boundary line increases, the amount of ink filled inside the boundary line may increase, and thus difference between the height of the edge of the electrode body in contact with the boundary line and the height of the center of the electrode body away from the boundary line decreases, so the height deviation of the electrode pattern may be reduced.

Accordingly, in the boundary line formation, the height of ejected ink may be 40% or more of target height of the electrode body.

When the boundary line formed in the boundary line formation and ink ejected in the electrode body formation do not mix with each other, the electrode body formation may be performed.

In order for the boundary line to perform the function of preventing the spreading of ink of which the electrode body is formed, the ink of the boundary line may not mix with the ink of the electrode body.

In this case, due to a dried state of the boundary line, the boundary line formed in the boundary line formation and the ink ejected in the electrode body formation may not mix with each other.

Even in the case of properties of ink used in the boundary line and ink used in the electrode body mixing with each other, the inks may not mix with each other according to the dried states of the inks, and when the boundary line and the ink of the electrode body do not mix with each other due to the dried state of the boundary line which is first formed, the boundary line may prevent the ink of the electrode body from spreading.

In addition, due to characteristic difference between ink used in the boundary line formation and the ink used in the electrode body formation, the boundary line formed in the boundary line formation and the ink ejected in the electrode body formation may not mix with each other.

When ink used in the boundary line and ink used in the electrode body have properties in which the inks do not mix with each other, the electrode body formation may be performed regardless of whether the boundary line is dried.

In this case, due to difference between a solvent of the ink used in the boundary line formation and a solvent of the ink used in the electrode body formation, the boundary line formed in the boundary line formation and the ink ejected in the electrode body formation may not mix with each other.

According to one aspect of the present disclosure, there is provided an electronic device manufacturing method including an electrode forming process, the process including: forming the boundary line corresponding to the edge of the electrode pattern by inkjet printing; and forming the electrode body filled inside the boundary line by inkjet printing, wherein height and width of the electrode pattern may be controlled by limiting ink printed in the electrode body formation such that the ink is prevented from going to an outside by the boundary line.

According to the present disclosure, since the electrode is formed through the inkjet printing, the precision of the electrode pattern which is the effect of the inkjet printing may be increased, and further, after the boundary line which prevents the spreading of ink is first formed, the electrode body may be formed, and accordingly, the electronic device having height of an electrode which cannot be achieved by a conventional inkjet printing may be manufactured.

The electronic device may be an MLCC.

By controlling height of ink printed in the boundary line formation, maximum height and height deviation of the electrode body printed may be controlled.

When the height of the inkjet-printed boundary line is excessively low compared to the target height of the electrode body, ink of which the boundary line is formed may not prevent the spreading of ink of which the electrode body is formed.

When the boundary line formed in the boundary line formation and ink ejected in the electrode body formation do not mix with each other, the electrode body formation may be performed.

Meanwhile, when the height of the inkjet-printed boundary line increases, the amount of ink filled inside the boundary line may increase, and thus difference between the height of the edge of the electrode body in contact with the boundary line and the height of the center of the electrode body away from the boundary line may decrease, so the height deviation of the electrode pattern may be reduced.

Accordingly, in the boundary line formation, the height of ejected ink may be 40% or more of the target height of the electrode body.

In order for the boundary line to perform the function of preventing the spreading of ink of which the electrode body is formed, the ink of the boundary line may not mix with the ink of the electrode body.

In this case, due to the dried state of the boundary line, the boundary line formed in the boundary line formation and the ink ejected in the electrode body formation may not mix with each other.

Even when the ink used in the boundary line and the ink used in the electrode body have properties in which the inks mix with each other, the inks may not mix with each other according to the dried state of the inks, and when the boundary line and the ink of the electrode body do not mix with each other due to the dried state of the boundary line which is first formed, the boundary line may prevent the ink of the electrode body from spreading.

In addition, due to characteristic difference between the ink used in the boundary line formation and the ink used in the electrode body formation, the boundary line formed in the boundary line formation and the ink ejected in the electrode body formation may not mix with each other.

When the ink used for the boundary line and the ink used for the electrode body do not mix with each other, the electrode body formation may be performed regardless of whether the boundary line is dried.

In this case, due to difference between the solvent of the ink used in the boundary line formation and the solvent of the ink used in the electrode body formation, the boundary line formed in the boundary line formation and the ink ejected in the electrode body formation do not mix with each other.

According to a last aspect of the present disclosure, there is provided an apparatus of forming an electrode of an electronic device in the method described above, the apparatus including: at least one boundary line nozzle for forming a boundary line by the inkjet printing; at least one electrode body nozzle for forming an electrode body by the inkjet printing; and a moving device for moving an inkjet printing nozzle.

In this case, a moving device for moving the boundary line nozzle and a moving device for moving the electrode body nozzle may be provided.

According to the electrode forming apparatus having the above-described configuration, the electrode body is formed after first forming the boundary line to prevent the spreading of ink by inkjet printing, thereby increasing the precision of the electrode pattern which is the effect of inkjet printing and enabling the formation of an electrode having height which cannot be achieved by conventional inkjet printing.

Furthermore, it is possible to reduce height difference between the edge of the electrode body close to the boundary line and the center of the electrode body.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating an electrode forming method according to an embodiment of the present disclosure;

FIG. 2 is a view illustrating a state in which maximum height and height deviation of an electrode are controlled by the electrode forming method according to the present disclosure;

FIG. 3 is a view illustrating a state in which a width of the electrode is controlled by the electrode forming method according to the present disclosure;

FIG. 4 is a view illustrating one embodiment in which the electrode forming method according to the present disclosure is performed;

FIG. 5 is a view illustrating for another embodiment in which the electrode forming method according to the present disclosure is performed;

FIG. 6 is a view illustrating an embodiment in which an electrode body is formed after drying a boundary line in an electrode forming process according to the present disclosure;

FIG. 7 is a view illustrating another embodiment in which the electrode body is formed after drying the boundary line in the electrode forming process according to the present disclosure;

FIG. 8 is a view illustrating an embodiment in which ink of the boundary line and ink of the electrode body do not mix with each other in the electrode forming process according to the present disclosure;

FIG. 9 is a view illustrating another embodiment in which ink of the boundary line and ink of the electrode body do not mix with each other in the electrode forming process according to the present disclosure;

FIG. 10 is a view illustrating a first method of forming an electrode pattern by using an electrode forming apparatus according to the embodiment of the present disclosure;

FIG. 11 is a view illustrating a second method of forming the electrode pattern by using the electrode forming apparatus according to the embodiment of the present disclosure;

FIG. 12 is a view illustrating a third method of forming the electrode pattern by using the electrode forming apparatus according to the embodiment of the present disclosure;

FIG. 13 is a view illustrating a fourth method of forming the electrode pattern by using the electrode forming apparatus according to the embodiment of the present disclosure;

FIG. 14 is a view illustrating a fifth method of forming the electrode pattern by using the electrode forming apparatus according to the embodiment of the present disclosure; and

FIG. 15 is a flowchart illustrating a typical MLCC manufacturing process.

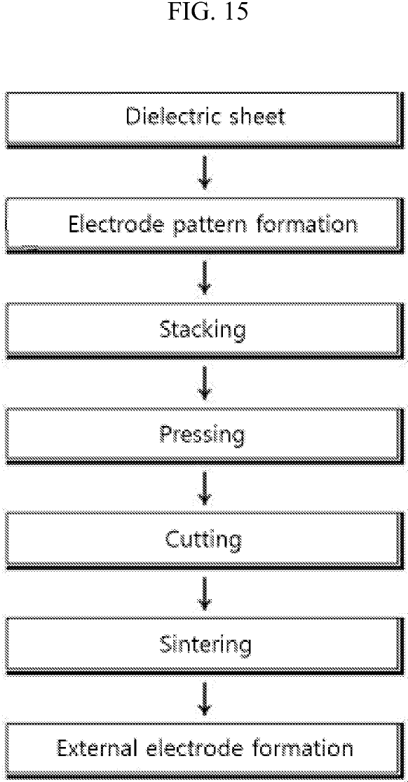

### DETAILED DESCRIPTION OF THE INVENTION

Embodiments according to the present disclosure will be described in detail with reference to the accompanying drawings.

However, the embodiments of the present disclosure may be modified in various other forms, and the scope of the present disclosure is not limited only to the embodiments described below. The shapes and sizes of elements in the drawings may be exaggerated for clearer description, and elements indicated by the same reference numerals in the drawings are the same elements.

In addition, throughout the specification, when a part is “connected” with another part, it includes not only the case of the part being “directly connected” with the another part but also the case of the part being “electrically connected” with the another part with still another element interposed therebetween. In addition, when a part “includes” or “is provided with” a certain component, this means that other components may be further included or provided without excluding the other components unless otherwise stated.

In addition, terms such as “first” and “second” are for distinguishing one component from another component, and the scope of the claims should not be limited by these terms. For example, a first component may be termed a second component, and similarly, a second component may also be termed a first component.

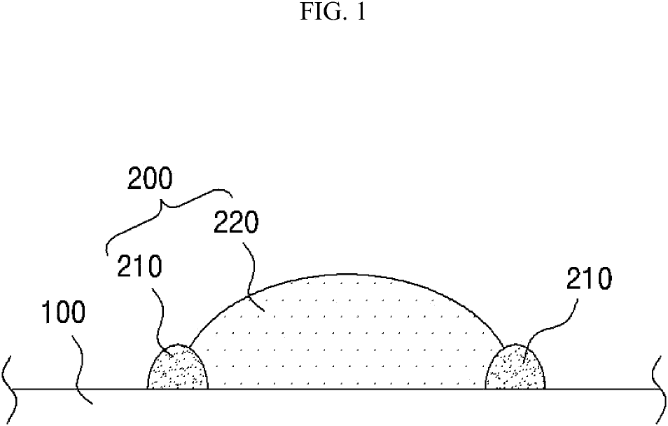

FIG. 1 is a view illustrating an electrode forming method according to the embodiment of the present disclosure.

Hereinafter, although the embodiment of the present disclosure is described based on a case in which an electrode is formed in an MLCC which is one of electronic devices, the present disclosure is not limited to manufacturing the MLCC and may be modified and applied to other electronic devices.

In the electrode forming method according to the embodiment, an electrode pattern 200 is formed on the surface of a dielectric sheet 100 by an inkjet printing method, and in this case, after the boundary line 210 corresponding to the edge of the electrode pattern 200 is formed by the inkjet printing, an electrode body 220 is formed inside the boundary line 210 by the inkjet printing.

In the present disclosure, filling the electrode body 220 inside the boundary line 210 after first forming the boundary line 210 is to secure enough height (that is, thickness between the dielectric sheet and end of ink) of the electrode pattern.

Accordingly, as the dielectric sheet 100 used in the electrode pattern of the present disclosure, a dielectric sheet used to manufacture an MLCC may be used almost without limitation.

In general, as for the dielectric sheet, after preparing slurry containing dielectric ceramic particles, a green sheet is generally formed by using a doctor blade molding machine. The slurry used for manufacturing the green sheet is prepared by evenly mixing ceramic powder (a ceramic raw material) and an additive and a sintering aid that influence electrical properties with an organic solvent, a binder, and a dispersant. The ceramic raw material mainly contains barium titanate-based oxide (BaTiO3) as a main component, and metal oxide and glass are used as additives and sintering aids. Polyamino acid is mainly used as the dispersant, polyvinylbutyral is mainly used as the binder, and ethanol and ethanol-based materials are used as the organic solvent. As high-capacity and miniaturization of electronic devices progress, an MLCC, which is one of representative passive electronic components, is also required to be miniaturized and have high capacity. Although the capacity of the MLCC can be increased depending on the dielectric, it is difficult to find a new dielectric, so efforts are being made to increase the number of dielectric layers by reducing the thickness of the dielectric. It is known that the thickness of a dielectric layer is required to be reduced to 0.5µm or less in order to satisfy the high-capacity of an MLCC which is currently required. However, in the case of (Ba, Sr) TiO3, which is a commercially available dielectric material, when thickness of a dielectric film is reduced to 200 nm or less, a dielectric constant is sharply decreased and stability of a dielectric is decreased. Recently, in order to solve this problem, research to manufacture a high-dielectric sheet based on a nanosheet is being conducted. When exfoliated two-dimensional nanosheets are used, each of the nanosheets has a very small layer thickness of several nanometers. Nevertheless, since each of the nanosheets is a single crystal, it is possible to obtain a dielectric thin film (sheet) for an MLCC having high capacity and high stability by effectively stacking the nanosheets. A dielectric sheet based on these nanosheets may also be freely applied in a range that does not impair the characteristics of the present invention.

Meanwhile, for miniaturization and high capacity of an MLCC, high precision of the electrode pattern 200 formed on the surface of the dielectric sheet 100 is required. Since the capacity of a capacitor is proportional to the area of an opposing electrode, it is necessary to form an electrode with a maximum area in limited space. In this case, due to the structure of the MLCC connecting external electrodes to stacked dielectric sheets, the electrode pattern is required to be formed in an accurate pattern so as to be in contact with only one of the two external electrodes. In addition, when multiple dielectric sheets are stacked, the ranges of overlapping electrode patterns are required to match each other as much as possible. Accordingly, it is very important to print an electrode pattern in a correct position so that the edges of the electrode pattern are clearly distinguished. In a conventional screen printing, when the viscosity of a slurry is increased to increase the sharpness of a printed electrode, the thickness (height of the electrode from the dielectric sheet) of the electrode is increased, and when the viscosity of a slurry is decreased to make an electrode thin, the sharpness of an printed electrode is decreased and has small width, which makes printing difficult.

The inkjet printing can precisely form the electrode pattern at the correct position compared to a conventional screen printing and can have a more decreased thickness (height from the dielectric sheet) of the printed electrode pattern, thereby having an advantage for manufacturing a small MLCC. However, the excessive thinness of the electrode pattern formed by the inkjet printing may be problematic. When the height of the electrode pattern is increased by increasing the amount of ink printed on the dielectric sheet by increasing the size or amount of the droplet of ink ejected by the inkjet printing, due to the characteristics of the inkjet printing in which ink with high fluidity is used, the ink spreads and the area of the electrode pattern is increased more than the area of the electrode pattern printed initially, and the shape of the pattern is unclear. According to the present disclosure, after the boundary line 210 is first formed by inkjet printing, ink is filled inside the boundary line 210 by inkjet printing to form the electrode body 220, and accordingly, the boundary line 210 may prevent the ink of the electrode body 220 from spreading to maintain enough height of the electrode body 220 which is inkjet-printed, and finally, an electrode can be formed to have height higher than height of an electrode formed by general inkjet printing.

In the present disclosure, a first reason for which the boundary line 210 is first formed to prevent the spreading of the ink of the electrode body 220 is to control the maximum height of the electrode body 220 which is inkjet-printed. The boundary line 210 which prevents the spreading of the ink of the electrode body 220 is first formed. Due to the characteristics of inkjet printing, ejected ink has a curved surface, and thus in present specification, height of each of the electrode body and the boundary line indicates a distance between a highest position thereof and the dielectric sheet.

In this case, since the boundary line 210 is required to prevent the spreading of the ink of the electrode body 220 printed inside the boundary line 210, the boundary line 210 is formed to have height of 40% or more of the target height of the electrode body 220.

By applying this configuration according to the present disclosure, a more precise electrode pattern can be formed compared to the screen printing, and a higher electrode pattern can be formed compared to the conventional inkjet printing.

In addition, in the present disclosure, a second reason for which the boundary line 210 to prevent the spreading of the ink of the electrode body 220 is first formed is to control the height deviation of the electrode body 220 which is inkjet-printed. As described above, due to the characteristics of inkjet printing, ejected ink has a curved surface, and thus the center and edge of the electrode body 220 have heights different from each other. In this case, when the height deviation which is height difference between the center and edge of the electrode body 220 is excessively large, the function of the electrode may be deteriorated. According to the present disclosure, since the electrode body 220 is printed inside the boundary line 210 which is first formed, a relatively larger amount of ink can be filled inside due to the height of the boundary line 210, and this can reduce the height deviation of the electrode body 220. In order to remove the height deviation of the electrode body 220, the boundary line 210 is preferably formed to be higher than height of the boundary line 210 determined to control the maximum height of the electrode body 220.

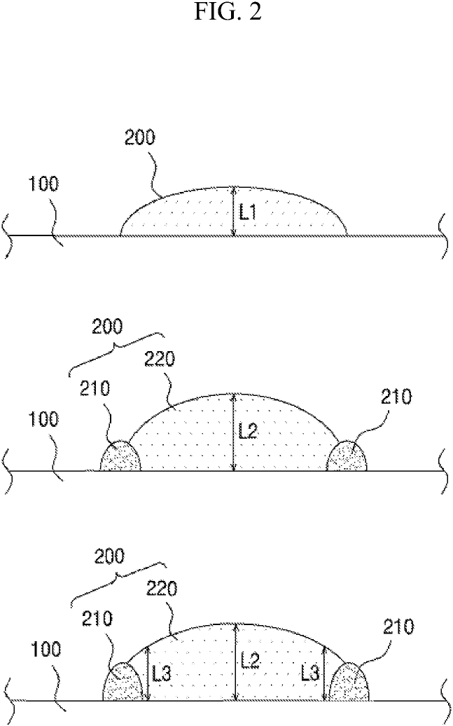

FIG. 2 is a view illustrating a state in which the maximum height and height deviation of the electrode are controlled by the electrode forming method according to the present disclosure.

As illustrated in the drawing, it can be seen that when the electrode body 220 is formed after first forming the boundary line 210, an electrode may be formed to have height L2 higher than height L1 of an electrode pattern 200 in the first drawing which is simply inkjet-printed.

In addition, it can be seen that in the third drawing in which a boundary line 210 is formed to have higher height and more ink is printed in an electrode body 220, compared to the second drawing, the edge of the electrode body 220 has increased height L3, and height difference between the center and edge of the electrode body 220 is decreased.

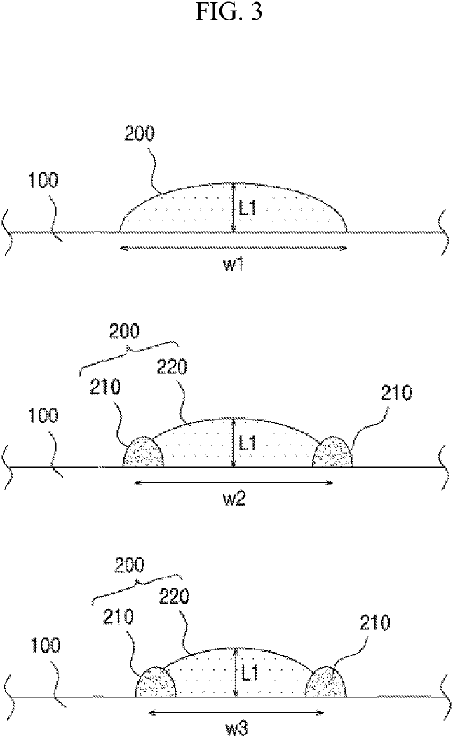

FIG. 3 is a view illustrating a state in which the width of an electrode is controlled by the electrode forming method according to the present disclosure.

As illustrated in the drawing, when the electrode body 220 is formed after first forming the boundary line 210, it is possible to form an electrode having the same height as height L1 of an electrode pattern 200 in a first drawing which is simply inkjet-printed and to form an electrode pattern 200 having a width smaller than the width of the electrode pattern 200 in the first drawing.

Furthermore, according to the position of the boundary line 210, the width of the electrode pattern can be changed to a width W2 or W3, so the width of the electrode can be effectively controlled.

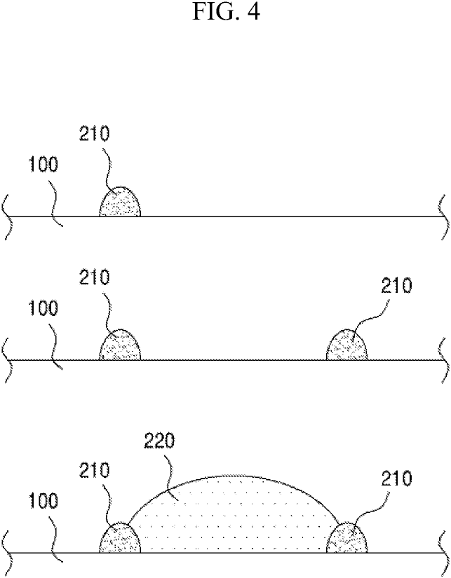

FIG. 4 is a view illustrating one embodiment in which the electrode forming method according to the present disclosure is performed.

In the embodiment to which the electrode forming method of the present disclosure is applied, as described in the drawing, first, the boundary line 210 is drawn one by one to form the boundary line 210. This method may be a suitable method when there is only one inkjet printing nozzle for forming the boundary line 210.

The process of forming one boundary line 210 is performed by the application of inkjet printing, and the boundary line 210 is formed to have height of 40% or more of the target height of the electrode body 220 such that the ink of the electrode body 220 can be prevented from spreading.

After forming the one boundary line 210, the electrode body 220 is formed by ejecting ink inside the boundary line 210.

The process of forming the electrode body 220 is performed by the application of inkjet printing. In this case, due to the characteristics of the spreading of ink, height of the electrode body is general limited by conventional inkjet printing, but in the embodiment of the present disclosure, the boundary line 210 is first printed and prevents the ink of the electrode body 220 from spreading, so in spite of the application of inkjet printing, the electrode body 220 can be formed to have height higher than the height of an electrode body formed by the conventional inkjet printing.

In this case, the inkjet printing nozzle by which the boundary line 210 is formed and the inkjet printing nozzle by which the electrode body 220 is formed may be the same nozzle, but separate inkjet printing nozzles are preferably used. As will be described in detail later, for various reasons, ink of which the boundary line 210 is formed and ink of which the electrode body 220 is formed may be different in composition, so it is preferable to use inkjet printing nozzles different from each other in the process of forming the boundary line 210 and the electrode body 220. In addition, important things in forming the boundary line 210 are to secure the precision of the electrode pattern and the prevention of the spreading of the ink of the electrode body 220, and an important thing in forming the electrode body 220 is to secure enough height of ejected ink, and thus a droplet of inkjet-printed ink for forming the boundary line 210 and a droplet of inkjet-printed ink for forming the electrode body 220 are preferable to be different in size, so it is preferable to use inkjet printing nozzles different from each other in the process of forming the boundary line 210 and the electrode body 220. Meanwhile, in order to form an electrode body 220 having a relatively large amount of ejected ink, a plurality of inkjet printing nozzles may be provided to simultaneously eject ink over a wide area.

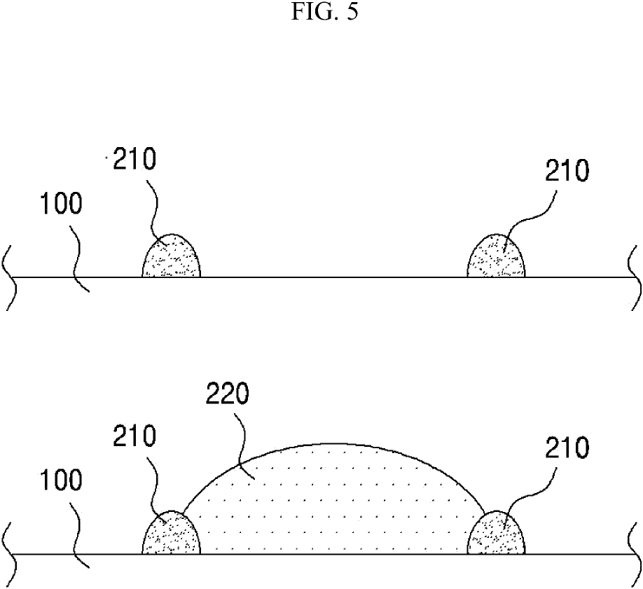

FIG. 5 is a view illustrating for another embodiment in which the electrode forming method according to the present disclosure is performed.

In the another embodiment to which the electrode forming method of the present disclosure is applied, as described in the drawing, first, a plurality of boundary lines 210 is simultaneously drawn to form the boundary lines 210. The illustrated embodiment shows a state in which a first boundary line 210 and a second boundary line 210 are formed simultaneously, and this method may be a suitable method in a case in which at least two inkjet printing nozzles for forming the boundary lines 210 are provided.

The process of forming a plurality of boundary lines 210 is performed by the inkjet printing, and each of the boundary lines 210 is formed to have height of 40% or more of the target height of the electrode body 220 such that the ink of the electrode body 220 can be prevented from spreading.

After forming the plurality of boundary lines 210, the electrode body 220 is formed by ejecting ink inside the boundary line 210.

The process of forming the electrode body 220 is performed by applying inkjet printing. In this case, due to the spreading of ink caused by general inkjet printing, the height of the electrode body is limited, but in the embodiment of the present disclosure, the boundary line 210 is first printed and prevents the ink of the electrode body 220 from spreading, so in spite of the application of the inkjet printing, the electrode body 220 can be formed to have higher height than before.

In this case, as described above, the inkjet printing nozzle by which the boundary line 210 is formed and the inkjet printing nozzle by which the electrode body 220 is formed may be the same nozzle, and in the process of forming the boundary line 210 and the electrode body 220, inkjet printing nozzles different from each other may be used.

Meanwhile, a process in which the electrode forming method according to the present disclosure is performed may be determined based on the state of an inkjet-printed boundary line.

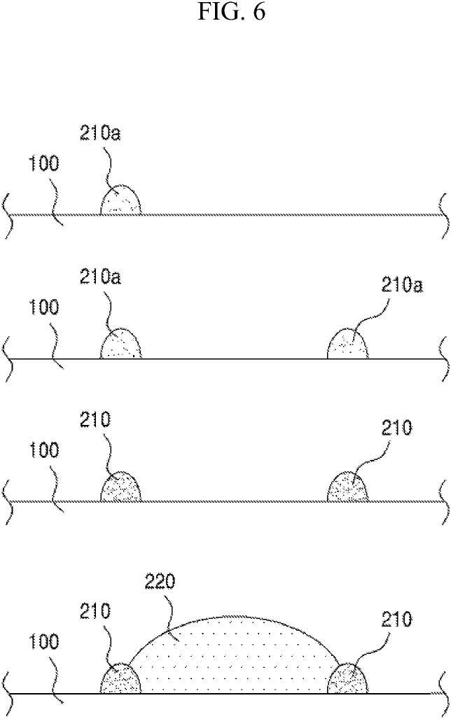

FIG. 6 is a view illustrating the embodiment in which the electrode body is formed after drying a boundary line in the electrode forming process according to the present disclosure.

In the electrode forming method of the present disclosure, the boundary line 210 is required to prevent the sharpness of the electrode pattern and the height of the electrode body 220 from decreasing due to the spreading of the ink of the electrode body 220 out of a predetermined range. In this case, since the boundary line 210 is also formed by inkjet printing for the sharpness of the pattern, ink of the boundary line 210 and ink of the electrode body 220 may be mixed and agglomerated into one ink, and in this case, the ink of the boundary line 210 may not prevent the ink of the electrode body 220 from spreading. Since whether the inks are mixed with each other depends on properties of the inks, the inks are difficult to be controlled, but even if the inks which are not dried mix with each other, the inks may not mix with each other according to dried states of the inks after the inks are inkjet-printed.

In the illustrated embodiment, a boundary line 210a which may mix with ink of an electrode body since a solvent contained in ink of the boundary line 210a remains after the ink is ejected from an inkjet printing nozzle, and a boundary line 210 which does not mix with ink of an electrode body 220 ejected from an inkjet printing nozzle since a considerable amount of a solvent contained in ink of the boundary line 210 has evaporated are illustrated separately. In this case, after the boundary line 210 is dried such that the ink of the boundary line 210 does not mix with the ink of the electrode body 220, the electrode body 220 may be formed. In this case, the boundary line 210 which does not mix with the ink of the electrode body 220 may be in a state close to an electrode by sintering. However, the boundary line 210 is sufficient as far as the boundary line 210 is at a level not to be mixed with the ink of the electrode body 220 simply due to decrease in a solvent contained in the ink of the boundary line 210 without the proceeding of processing of the boundary line 210 according to the level of the sintering. To this end, ink for forming the boundary line 210 may have rapid-drying properties such that the ink dries rapidly. By controlling the type and amount of solvent and binder, the drying speed of ink may be controlled. The boundary line 210 has an area smaller than the entire area of the electrode pattern, and position of the boundary line 210 corresponds to the edge of the electrode pattern. Accordingly, the boundary line 210 has relatively little influence on the properties of the electrode, and thus has little effect on the performance of an electronic device such as an MLCC which is a finished product when the boundary line 210 is formed of composition of ink prepared by emphasizing the drying speed of the ink.

However, in the process of forming the electrode body 220, ink is required to be printed to have height which is generally difficult to be printed by inkjet printing, and the boundary line 210 prevents the ink of the electrode body 220 from spreading. Accordingly, the height of the boundary line 210 is required to be determined such that the electrode body 220 can be printed to have desired height, and the boundary line 210 is formed to have height of 40% or more of the desired height of the electrode body 220. In this case, the height of the boundary line 210 is required to be based on time at which the electrode body 220 is printed, and the boundary line 210 is required not to be mixed with the ink of the electrode body 220. Accordingly, based on the state in which the boundary line 210 does not mix with the ink of the electrode body 220, the boundary line 210 is formed to have the height of 40% or more of the height of the electrode body 220. In consideration of evaporation of the solvent of the boundary line 210 until the boundary line 210 does not mix with the electrode body 220, the height of the boundary line 210 immediately after the boundary line 210 is printed by the inkjet printing may be higher than the height of the boundary line 210 before the evaporation.

The embodiment illustrated in FIG. 6 illustrates a state in which the electrode body 220 is formed after forming each of the boundary lines 210 which do not mix with the ink of the electrode body 220, based on the embodiment illustrated in FIG. 4.

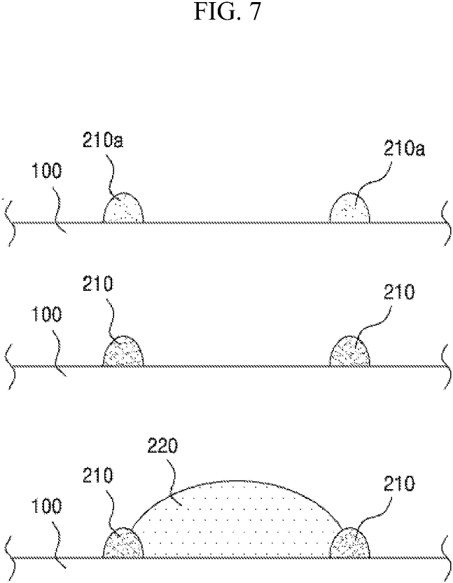

FIG. 7 is a view illustrating another embodiment in which the electrode body is formed after drying the boundary line in the electrode forming process according to the present disclosure.

As in the embodiment illustrated in FIG. 5, when a plurality of boundary lines 210 is formed, the plurality of boundary lines 210, as a whole, may be more rapidly converted into the boundary lines 210 which do not mix with ink of the electrode body 220.

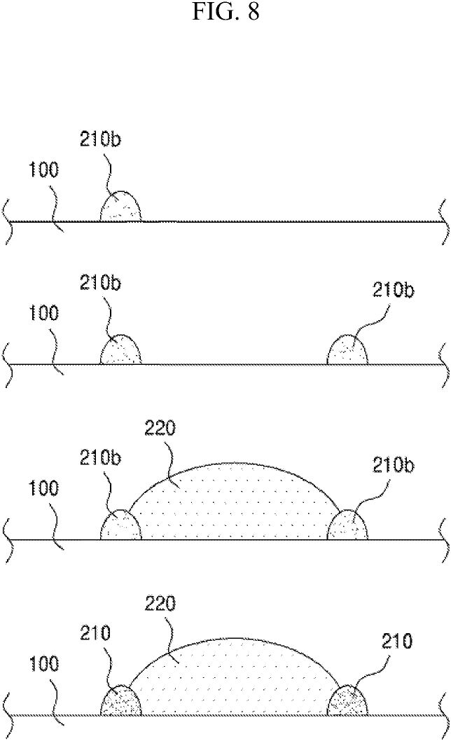

FIG. 8 is a view illustrating an embodiment in which ink of the boundary line and ink of the electrode body do not mix with each other in the electrode forming process according to the present disclosure.

In the electrode forming method of the present disclosure, the boundary line 210 is required to function to prevent the decrease of the sharpness of the electrode pattern and the decrease of the height of the electrode body 220 due to the spreading of ink of the electrode body 220 out of a predetermined range. In this case, since the boundary line 210 is also formed by the inkjet printing for the sharpness of the electrode pattern, ink of the boundary line 210 and ink of the electrode body 220 may mix with each other and agglomerate into one ink. In this case, the boundary line 210 may not prevent the spreading of the ink of the electrode body 220.

As illustrated in the drawing, even in the state of a boundary line 210b having a remaining solvent contained in ink after the ink is ejected from the inkjet printing nozzle, when property of the ink of the boundary line 210 is controlled such that the ink of the boundary line 210 does not mix with ink of the electrode body 220 ejected later from the inkjet printing nozzle, the electrode body 220 may be immediately formed regardless of whether the boundary line 210b is dried.

In this case, to prevent ink of the electrode body 220 and ink of the boundary line 210b from mixing with each other, the two inks are most preferably provided such that solvents of the two inks do not mix with each other. In addition, ink of the electrode body 220 and ink of the boundary line 210b may not be mixed with each other by using the properties of compositions constituting the inks. For example, by controlling the type and amount of a solvent and a binder, ink of the electrode body 220 and ink of the boundary line 210b may not be mixed with each other. The boundary line 210 has an area smaller than the entire area of the electrode pattern and the position of the boundary line 210 corresponds to the edge of the electrode pattern. Accordingly, the boundary line 210 has relatively little influence on the properties of the electrode, and thus has little effect on performance of an electronic device such as an MLCC which is a finished product even with the composition of inks of the electrode body 220 and the boundary line 210b prepared by emphasizing properties of the inks such that the inks of the electrode body 220 and the boundary line 210b do not mix with each other.

However, in the process of forming the electrode body 220, ink is required to have height to which it is generally difficult to print the ink by inkjet printing, and to this end, the boundary line 210 is required to prevent the ink of the electrode body 220 from spreading. Accordingly, the height of the boundary line 210 is required to be determined such that the electrode body 220 can be printed to have desired height, and the boundary line 210 is formed to have height of 40% or more of the desired height of the electrode body 220. In this case, the height of the boundary line 210 is required to be based on time at which the electrode body 220 is printed. In the embodiment, since ink of which the boundary line 210 is formed and ink of which the electrode body 220 is formed do not mix with each other, the boundary line 210 immediately after the boundary line 210 is printed by inkjet printing may be formed to have height of 40% or more of the desired height of the electrode body 220. However, since there is time difference between the process of forming the boundary line 210 and the process of forming the electrode body 220, in consideration of evaporation of the solvent of the boundary line 210, the height of the boundary line 210 immediately after the boundary line 210 is printed by inkjet printing may be higher than the height of the boundary line 210 before the evaporation.

The embodiment illustrated in FIG. 8 illustrates a state in which the electrode body 220 is formed after forming each of the boundary lines 210 which do not mix with the ink of the electrode body 220, based on the embodiment illustrated in FIG. 4.

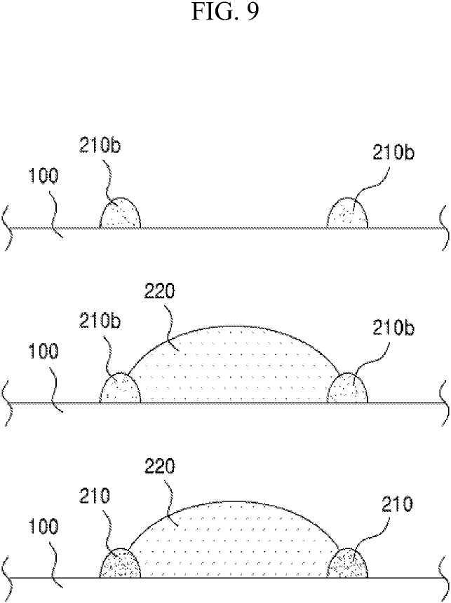

FIG. 9 is a view illustrating another embodiment in which ink of the boundary line and ink of the electrode body do not mix with each other in the electrode forming process according to the present disclosure.

As in the embodiment illustrated in FIG. 5, when a plurality of boundary lines 210 is formed, the plurality of boundary lines 210, as a whole, may be more rapidly converted into the boundary lines 210 which do not mix with ink of the electrode body 220.

Hereinafter, the configuration of an electrode forming apparatus using the inkjet printing method used in the electrode forming method of the present disclosure will be described.

The electrode forming apparatus using the inkjet printing method according to the present disclosure includes a nozzle which ejects ink for forming an electrode and a moving device for moving the nozzle, and may be variously configured in such a manner that the number and combination of nozzles and moving devices are changed.

The following description is about the number of nozzles and moving devices based on a set of electrode forming apparatus combined to form one electrode pattern. A plurality of electrode patterns is formed on a surface of one dielectric sheet, and the electrode patterns may be formed by repeated performance of one set of electrode forming apparatus described below, or may be simultaneously formed by using a plurality of sets of electrode forming apparatus.

First, one simplest set of electrode forming apparatus may be composed of one nozzle which ejects ink and one moving device which moves the nozzle.

First, the electrode forming method of the present disclosure may be performed in such a manner that the boundary line is formed by one nozzle ejecting ink while the nozzle is moving and then the nozzle ejects ink while moving inside the boundary line to form the electrode body.

In this case, since the ink ejected through the one nozzle cannot be changed, the same kind of ink is required to be used to form the boundary line and the electrode body. In the case in which the boundary line and the electrode body are formed by using the same ink, ink of which the boundary line is formed and ink of which the electrode body is formed mix with each other, and thus the boundary line may not prevent the ink of the electrode body from spreading. Accordingly, in the case in which the electrode forming apparatus using one nozzle is used, the electrode body is preferably formed after a solvent of ink of the boundary line evaporates such that the ink of the boundary line which is first formed does not mix with the ink of the electrode body which is later formed.

This method may be applied even to a case in which even if one set of electrode forming apparatus is provided with a plurality of nozzles ejecting ink, the same ink is supplied to all of the nozzles.

Another set of electrode forming apparatus may include a plurality of nozzles ejecting ink, and an inkjet printing nozzle printing ink for forming the boundary line and an inkjet printing nozzle printing ink for forming the electrode body such that the inkjet printing nozzles are configured separately.

First, in the case in which the inkjet printing nozzle for forming the boundary line and the inkjet printing nozzle for forming the electrode body are separated from each other, one set of boundary line nozzle for forming the boundary line may be provided. In addition, as for the moving device for moving a nozzle, a moving device which moves the inkjet printing nozzle for forming the boundary line and a moving device which moves the inkjet printing nozzle for forming the electrode body may be the same or may be separated from each other.

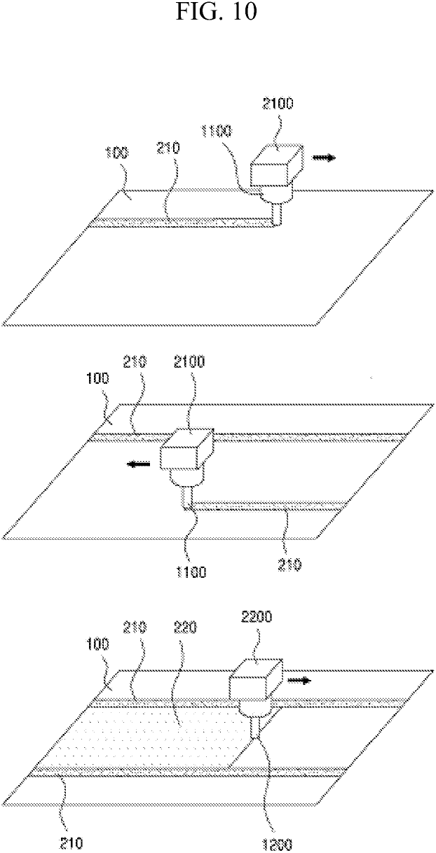

FIG. 10 is a view illustrating a first method of forming the electrode pattern by using the electrode forming apparatus according to the embodiment of the present disclosure.

As illustrated in the drawing, in a method of forming the boundary lines which face each other by being spaced apart from each other by one boundary line nozzle 1100, it is preferable that a first boundary line 210 is formed while the first moving device 2100 for moving the boundary line nozzle 1100 moves the boundary line nozzle 1100 in a horizontal straight direction in the drawing, and a second boundary line 210 is formed while the first moving device 2100 moves the boundary line nozzle 1100 in a direction opposite to the direction in which the first boundary line 210 is formed after the first moving device 2100 moves the boundary line nozzle 1100 in a vertical direction in the drawing.

As illustrated in the drawing, after the boundary lines 210 which are disposed by facing each other are formed, the electrode body 220 is formed while the second moves device 2200 for moving an electrode body nozzle 1200 moves the electrode body nozzle 1200 between the boundary lines 210.

Accordingly, when the boundary line 210 and the electrode body 220 are sequentially formed, there is little difference between a case in which the first moving device 2100 for moving the boundary line nozzle 1100 and the second moving device 2200 for moving the electrode body nozzle 1200 are the same and a case in which the first moving device 2100 and the second moving device 2200 are separated from each other.

However, when the formation of the boundary line 210 and the formation of the electrode body 220 can be continuously performed since ink of which the boundary line 210 is formed and ink of which the electrode body 220 is formed do not mix with each other, the electrode body 220 may be formed when the second boundary line 210 is not completely formed.

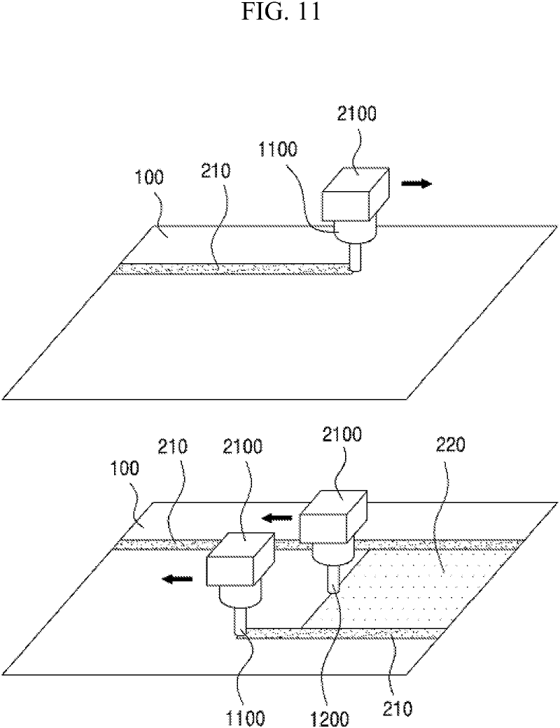

FIG. 11 is a view illustrating a second method of forming the electrode pattern by using the electrode forming apparatus according to the embodiment of the present disclosure.

As illustrated in the drawing, behind the boundary line nozzle 1100 in a direction in which the boundary line nozzle 1100 moves to form the second boundary line 210, the first and second boundary lines 210 face each other, and thus the electrode body nozzle 1200 can form the electrode body 220 while the electrode body nozzle 1200 moves by following the boundary line nozzle 1100.

In order to form the electrode pattern in such a manner, the first moving device 2100 for moving the boundary line nozzle 1100 and the second moving device 2200 for moving the electrode body nozzle 1200 are preferably provided.

When the inkjet printing nozzle for forming the boundary line and the inkjet printing nozzle for forming the electrode body are separated from each other, the inkjet printing nozzle for forming the boundary line may include a plurality set of inkjet printing nozzles. In addition, as for the moving device for moving the nozzle, the moving device which moves the inkjet printing nozzle for forming the boundary line and the moving device which moves the inkjet printing nozzle for forming the electrode body may be the same or may be separated from each other.

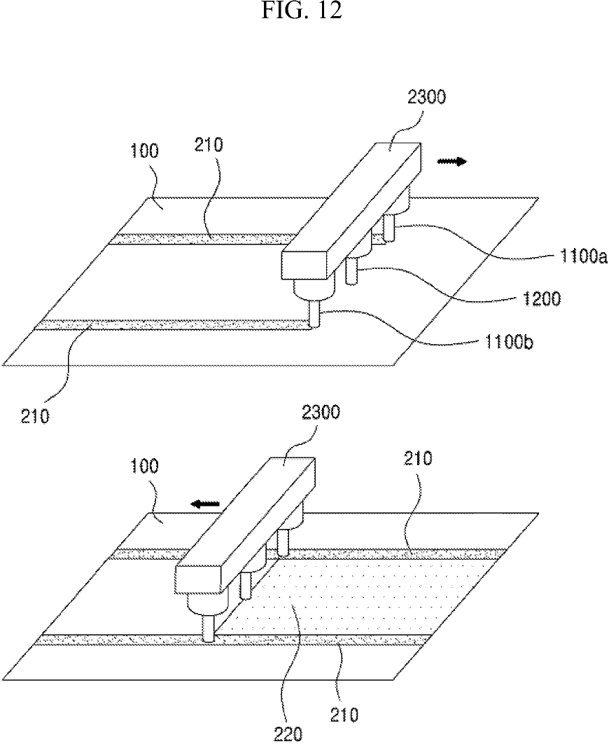

FIG. 12 is a view illustrating a third method of forming the electrode pattern by using the electrode forming apparatus according to the embodiment of the present disclosure.

As illustrated in the drawing, in a method of forming the boundary lines which face each other by being spaced apart from each other by using a plurality of boundary line nozzles 1100a and 1100b, the two boundary lines 210 may be formed while the two boundary line nozzles 1100a and 1100b are moved in horizontal straight directions by one third moving device 2300.

Next, while the electrode body nozzle 1200 moves in a horizontal straight direction between the boundary lines 210 which are disposed by facing each other, the electrode body 220 is formed. In this case, when the one third moving device 2300 is provided to move the boundary line nozzle 1100 and the electrode body nozzle 1200, as illustrated in the drawing, the moving device may move the boundary line nozzles 1100a and 1100b and the electrode body nozzle 1200 together and may sequentially perform the process of forming the boundary line and the process of forming the electrode body while reciprocating the nozzles.

However, when the formation of the boundary line 210 and the formation of the electrode body 220 can be continuously performed since ink of which the boundary line 210 is formed and ink of which the electrode body 220 is formed do not mix with each other, the electrode body 220 may be formed without the facing boundary lines 210 being completed.

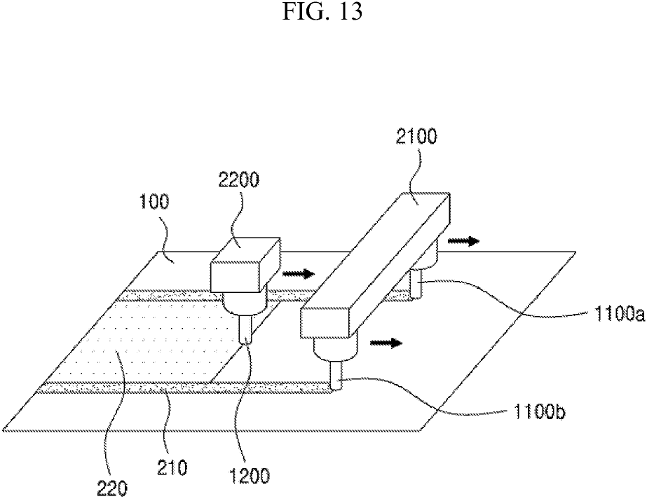

FIG. 13 is a view illustrating a fourth method of forming the electrode pattern by using the electrode forming apparatus according to the embodiment of the present disclosure.

As illustrated in the drawing, behind the two boundary line nozzles 1100a and 1100b in directions in which the two boundary line nozzles 1100a and 1100b move to form the boundary line 210 facing each other, the boundary lines 210 face each other, and thus the electrode body nozzle 1200 can form the electrode body 220 while moving by following the two boundary line nozzles 1100a and 1100b.

In order to form the electrode pattern in such a method, the first moving device 2100 for moving the plurality of boundary line nozzles 1100a and 1100b and the second moving device 2200 for moving the electrode body nozzle 1200 are preferably provided.

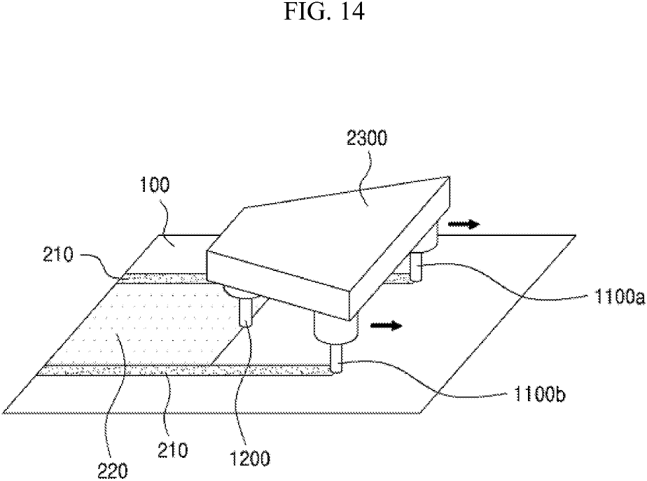

FIG. 14 is a view illustrating a fifth method of forming the electrode pattern by using the electrode forming apparatus according to the embodiment of the present disclosure.

Unlike the method of forming the electrode pattern illustrated in FIG. 13, the plurality of boundary line nozzles 1100 and the electrode body nozzle 1200 are moved by one third moving device 2300, and intervals at which the nozzles are arranged are controlled, and as illustrated in the drawing, the boundary line nozzles 1100 may be located at the front side of the third moving device 2300 in the moving direction thereof, and the electrode body nozzle 1200 may be located at the rear side of the third moving device 2300 in the moving direction by being spaced by a predetermined interval apart from the boundary line nozzles 1100 to move by following the boundary line nozzles 1100.

The present disclosure has been described above through the exemplary embodiments, but the above-described embodiments are merely illustrative of the technical spirit of the present disclosure, and those skilled in the art will understand that various changes are possible within the scope of the present disclosure without departing from the technical spirit of the present disclosure. Accordingly, the protection scope of the present disclosure should be interpreted by matters described in the claims, not specific embodiments, and all technical ideas within the equivalent range should be construed as being included in the scope of the present disclosure.

What is claimed is:

1. A method of forming an electrode of an electronic device for manufacturing the electronic device, the method comprising:
forming a boundary line corresponding to an edge of an electrode pattern by inkjet printing; and
forming an electrode body filled inside the boundary line by inkjet printing,
wherein height and width of the electrode pattern are controlled by limiting ink printed in the electrode body formation such that the ink is prevented from going to an outside by the boundary line.

2. The method of claim 1, wherein by controlling height of ink printed in the boundary line formation, maximum height and height deviation of the electrode body printed are controlled.

3. The method of claim 1, wherein when the boundary line formed in the boundary line formation and ink ejected in the electrode body formation do not mix with each other, the electrode body formation is performed.

4. The method of claim 3, wherein due to a dried state of the boundary line, the boundary line formed in the boundary line formation and the ink ejected in the electrode body formation do not mix with each other.

5. The method of claim 3, wherein due to characteristic difference between ink used in the boundary line formation and the ink used in the electrode body formation, the boundary line formed in the boundary line formation and the ink ejected in the electrode body formation do not mix with each other.

6. The method of claim 5, wherein due to difference between a solvent of the ink used in the boundary line formation and a solvent of the ink used in the electrode body formation, the boundary line formed in the boundary line formation and the ink ejected in the electrode body formation do not mix with each other.

7. An electronic device manufacturing method comprising an electrode forming process, the process comprising:
forming a boundary line corresponding to an edge of an electrode pattern by inkjet printing; and
forming an electrode body filled inside the boundary line by inkjet printing,
wherein height and width of the electrode pattern are controlled by limiting ink printed in the electrode body formation such that the ink is prevented from going to an outside by the boundary line.

8. The method of claim 7, wherein by controlling height of ink printed in the boundary line formation, maximum height and height deviation of the electrode body printed are controlled.

9. The method of claim 7, wherein when the boundary line formed in the boundary line formation and ink ejected in the electrode body formation do not mix with each other, the electrode body formation is performed.

10. The method of claim 9, wherein due to a dried state of the boundary line, the boundary line formed in the boundary line formation and the ink ejected in the electrode body formation do not mix with each other.

11. The method of claim 9, wherein due to characteristic difference between ink used in the boundary line formation and the ink used in the electrode body formation, the boundary line formed in the boundary line formation and the ink ejected in the electrode body formation do not mix with each other.

12. The method of claim 11, wherein due to difference between a solvent of the ink used in the boundary line formation and a solvent of the ink used in the electrode body formation, the boundary line formed in the boundary line formation and the ink ejected in the electrode body formation do not mix with each other.

13. An apparatus of forming an electrode of an electronic device in the method of claim 1, the apparatus comprising:
at least one boundary line nozzle for forming a boundary line by inkjet printing;
at least one electrode body nozzle for forming an electrode body by inkjet printing; and
a moving device for moving an inkjet printing nozzle.

14. The apparatus of claim 13, wherein a moving device for moving the boundary line nozzle and a moving device for moving the electrode body nozzle are provided.
